(19) United States
(12) Patent Application Publication
(10) Pub. No.: US 2003/0063677 A1
(43) Pub. Date: Apr. 3, 2003

(54) Multi-level coding for digital communication

(75) Inventors: Jason A. Mix, Hillsboro, OR (US); Michael W. Leddige, Beaverton, OR (US); Howard L. Heck, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Intel Corporation, Santa Clara, CA

(21) Appl. No.: 09/968,641

(22) Filed: Sep. 28, 2001

(51) Int. Cl. H04L 27/00

(52) U.S. Cl. 375/259; 375/316; 375/295; 375/291

(57) ABSTRACT

A method and apparatus for the multi-level coding for communication for computer bus data transfers are described. An input signal and delayed versions of the input are combined to create an encoded output signal. An input signal and delayed versions of the output are combined to create a decoded output signal.

### FIELD OF THE INVENTION

The present invention pertains to digital communications. More particularly, the present invention relates to a method and apparatus for multi-level coding for communication of data for transfer via a computer bus.

### BACKGROUND OF THE INVENTION

As microprocessors become faster, the need for faster computer bus transfers increases. However, a problem faced by computer bus designers is that the physical interconnect is bandwidth limited. That is, as the frequency of data across a bus increases, the percentage of energy received versus energy transmitted may decrease causing distortion in a digital waveform being sent across the bus.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment;

FIG. 2 is a block diagram of a computer system;

FIG. 3 illustrates in block diagram form one embodiment of a duo-binary system;

FIG. 4 illustrates one method of duo-binary encoding;

FIG. 5 illustrates one method of duo-binary decoding;

FIG. 6 illustrates one embodiment of n-level encoding; and

FIG. 7 illustrates one embodiment of n-level decoding.

### DETAILED DESCRIPTION

A method and apparatus for the multi-level coding for communication for computer bus data transfers are described.

For purposes of discussing the invention, it is to be understood that various terms are used by those knowledgeable in the art to describe techniques and approaches.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, delayed, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of skill in the art will immediately appreciate that the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. Additionally, the invention may be practiced in dedicated devices that may or may not be computer based, such as, bus switches, routers, networking devices, etc. The invention can also be practiced in distributed computing environments where tasks are performed by remote processing devices that are linked through a communications network and/or channel. Such a communications channel may include, but is not limited to, a communications network, LANs, high speed busses, on-chip paths, etc. Thus, the invention may be practiced, for example on a computer chip where communications may be from one logic block to another. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

As used in this description the term adder, additive function, etc., refer to an additive function regardless of whether the inputs to the additive function are analog or digital signals. The terms subtractor, subtracter, etc., refer to a subtractive function regardless of whether the inputs to the subtractive function are analog or digital. The term adder-subtracter likewise refers to a functional unit capable of the additive and subtractive functionality regardless of whether it is operating on analog or digital signals. For purposes of clarity, when appropriate, distinctions between analog and digital signals may be made. What is to be appreciated is that the use of a term, such as, subtractor is not to imply an input and/or output as either analog or digital.

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Additionally, those knowledgeable in the art refer customarily to certain parameters of signals by a variety of names. For example, frequency (f) may be referred to in an instance, however one skilled in the art recognizes that the time period of a periodic signal is the inverse of the frequency (1/f) and so reference to either is readily understood to relate to the other. Similarly, ½f is referred to as the minimum pulse width. Likewise, in the digital domain, while signals may be composed of combinations of digital signals, it is understood that a period refers to the smallest time interval for a signal to go from one state back to that same state again (for example, from a low level to a high level, back to a low level). For example, if a 100 MHz clock is the fundamental frequency, it is understood by those knowledgeable in the art that the period is 10 ns (1/f), and that the minimum pulse width is 5 ns (½f). Thus, while signals may be composed of longer time periods of high and/or low signals, the fundamental minimum integer increment is 5 ns. The minimum pulse width (½f) is often referred to as the minimum bit period, because it is the smallest period of time in which a bit or single value of a signal may be sent. Thus, the minimum bit period for a system having a 100 MHz fundamental clock frequency would be 5 ns (½*100 MHz=5 ns).

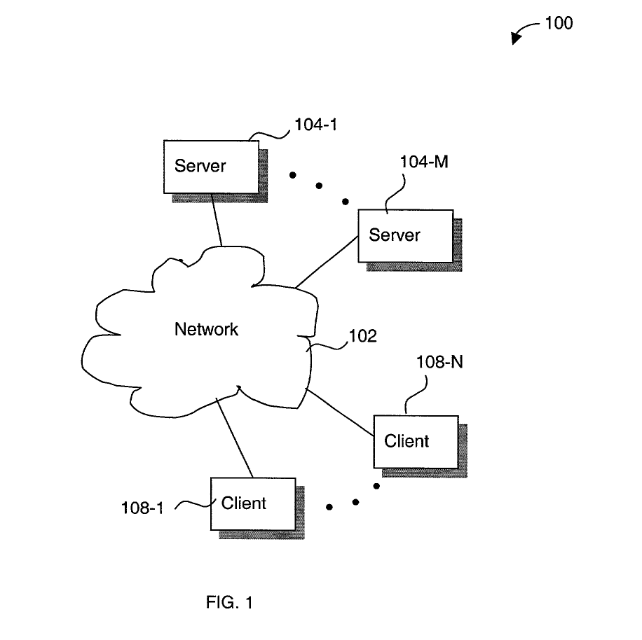

FIG. 1 illustrates a network environment 100 in which the techniques described may be applied. As shown, several computer systems in the form of M servers 104-1 through 104-M and N clients 108-1 through 108-N are connected to each other via a network 102, which may be, for example, the Internet. Note that alternatively the network 102 might be or include one or more of: a Local Area Network (LAN), Wide Area Network (WAN), satellite link, fiber network, cable network, or a combination of these and/or others. The method and apparatus described herein may be applied to essentially any type of communicating means or device whether local or remote, such as a LAN, a WAN, a system bus, a disk drive, storage, etc.

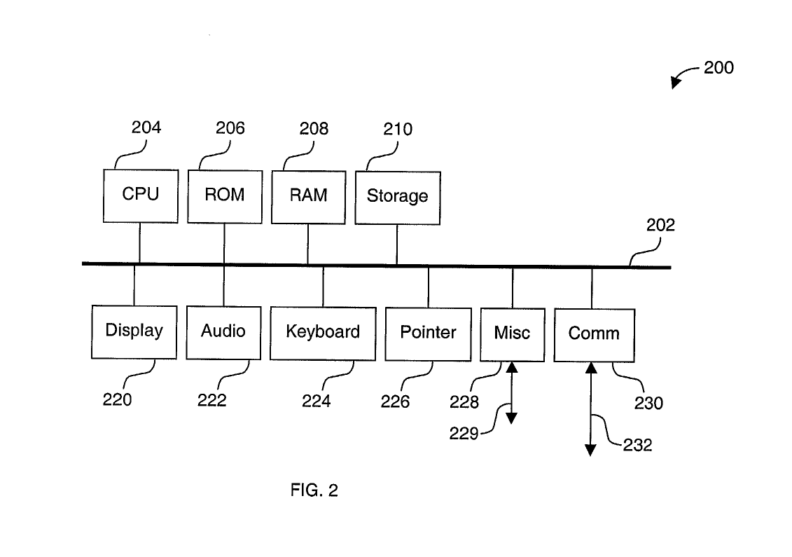

FIG. 2 illustrates a computer system 200 in block diagram form, which may be representative of any of the clients and servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), etc. The CPU 204 may be a single, multiple, or even a distributed computing resource. The ROM 206 may be any type of non-volatile memory, which may be programmable such as, mask programmable, flash, etc. RAM 208 may be, for example, static, dynamic, synchronous, asynchronous, or any combination. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Audio 222 may be a monophonic, stereo, three dimensional sound card, etc. The keyboard 224 may be a keyboard, a musical keyboard, a keypad, a series of switches, etc. The pointer 226, may be, for example, a mouse, a touchpad, a trackball, joystick, etc. I/O devices 228, might be a voice command input device, a thumbprint input device, a smart card slot, a Personal Computer Card (PC Card) interface, virtual reality accessories, etc., which may optionally connect via an input/output port 229 to other devices or systems. An example of a miscellaneous I/O device 228 would be a Musical Instrument Digital Interface (MIDI) card with the I/O port 229 connecting to the musical instrument(s). Communications device 230 might be, for example, an Ethernet adapter for local area network (LAN) connections, a satellite connection, a settop box adapter, a Digital Subscriber Line (xDSL) adapter, a wireless modem, a conventional telephone modem, a direct telephone connection, a Hybrid-Fiber Coax (HFC) connection, cable modem, etc. The external connection port 232 may provide for any interconnection, as needed, between a remote device and the bus system 202 through the communications device 230. For example, the communications device 230 might be an Ethernet adapter, which is connected via the connection port 232 to, for example, an external DSL modem. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

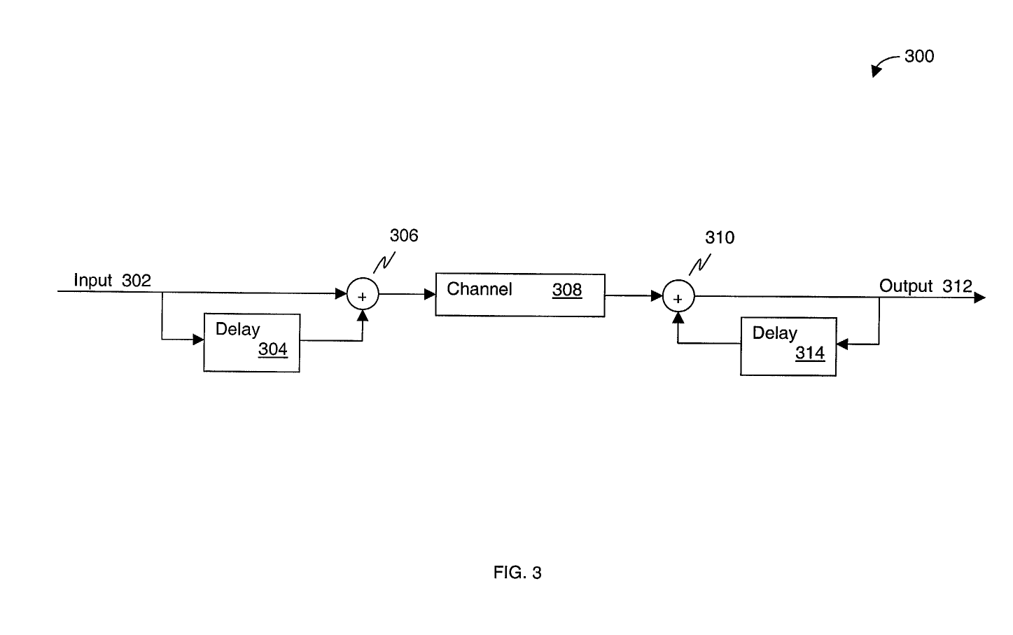

FIG. 3 illustrates in block diagram form one embodiment of a duo-binary system 300. In this embodiment, the Input 302 signal is routed to a Delay 304 and a combination block 306, here shown as an additive function. The output of the combination block 306 then goes into a Channel 308. After going through the Channel 308 the signal goes into another combination block 310, also shown here as an additive function. Also coming into the combination block 310 is the output from Delay 314 whose input is the output of the combination block 310 which forms the Output 312.

For one embodiment of a duo-binary system, such as that shown in FIG. 3, the combination blocks 306 and 310 may have other functions. For example, instead of an additive function, they may be subtractive, or exclusive-or (XOR), etc. in nature. Additionally, it is to be appreciated that the Delays 304 and 314 may be in one embodiment, a single bit delay, and in other embodiments a combination of bit delays.

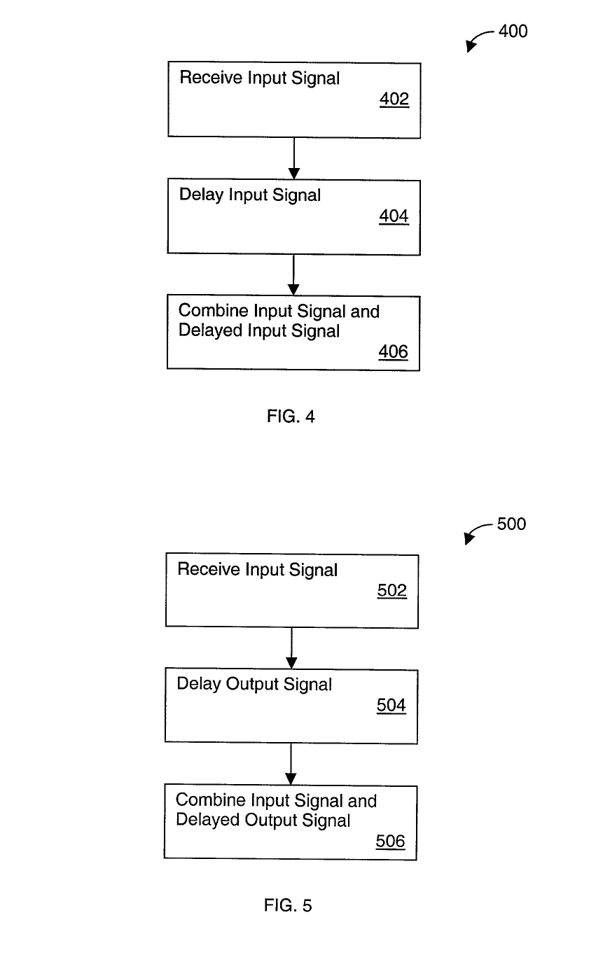

FIG. 4 illustrates one method of duo-binary encoding 400. An input signal is received at 402, the input signal is delayed 404, and then the input signal and the delayed input signal are combined 406.

FIG. 5 illustrates one method of duo-binary decoding 500. An input signal is received at 502, the output signal is delayed 504, and then the input signal and the delayed output signal are combined 506.

The embodiment illustrated in FIG. 3, may be implemented in hardware, for example on an integrated circuit. One embodiment may use an XOR gate for the additive functions 306 and 310, for example, where the signals are digital in nature. If the signals are analog in nature, then the additive functionality may be achieved by, for example, a non-linear element, a mixer, an analog adder, etc. The Delays 304 and 314 may be implemented, in the case of a single bit delay, by use of, for example, a D-type flip flop clocked at the fundamental bit rate frequency of the input signal where the signals are digital in nature. Other embodiments may use, for example, shift-register logic, self-resetting domino logic, etc. In the analog domain the delay may be, but is not limited to, a length of wire, an RC, LC, and/or RLC circuitry (R=resistor, C=capacitor, L=inductor). The Channel 308 may represent for example, the traces on a printed circuit board, a cable, a wire, an on-chip interconnection, a wire between devices on the same substrate, a wave guide or free space for a radio frequency (RF) signal and/or optical signal, etc.

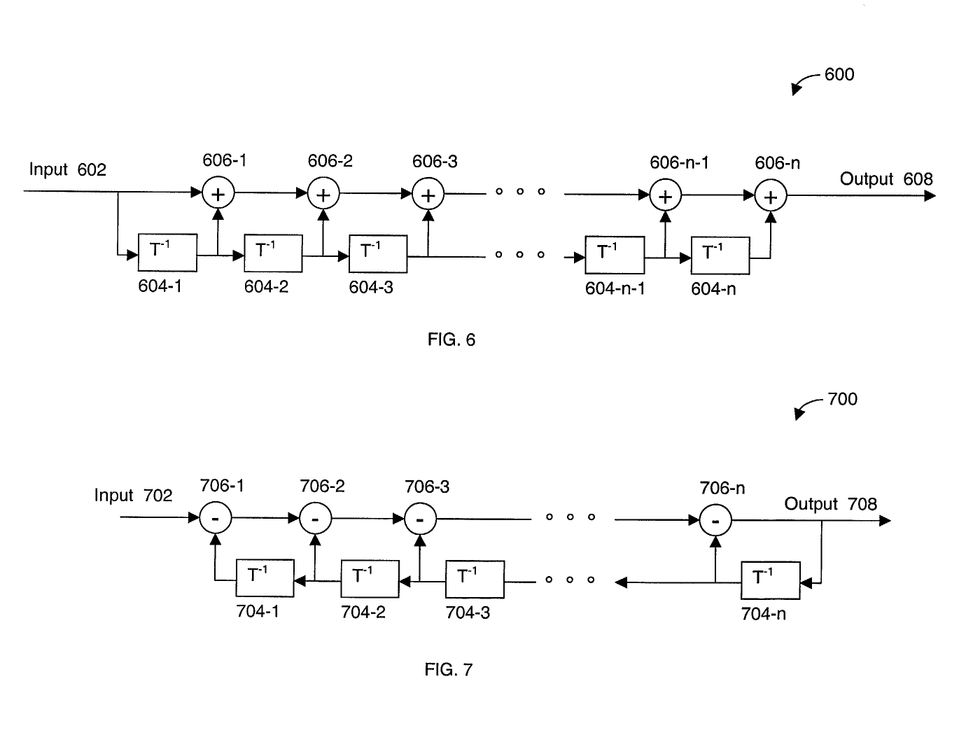

FIG. 6 illustrates one embodiment 600 of n-level encoding. In this illustration, T⁻¹ denotes a time delay function. In this embodiment the additive function at the first stage 606-1 receives the input 602 and a delayed version (via delay 604-1) of the input signal 601. The output of the first stage additive function 606-1 goes to the second stage additive function 606-2 as does a second delayed version (via delays 604-1 and 604-2) of the input signal 602. This progression, may repeat for an arbitrary value n. In FIG. 6 stages 3, n1, and n are also illustrated. The output 608 is received from the additive function output of stage n.

FIG. 7 illustrates one embodiment 700 of n-level decoding. In this illustration, T⁻¹ denotes a time delay function. In this embodiment the subtractive function at the first stage 706-1 receives the input 702 and a delayed version (via delays 704-n through 704-2, 704-1,) of the output signal 708. The output of the first subtractive additive function 706-1 goes to the second stage subtractive function 706-2 as does a delayed version (via delays 704-n through 704-2) of the output signal 708. This progression, may repeat for an arbitrary value n. In FIG. 7 stages 3, and n are also illustrated. The output 708 is received from the subtractive function output of stage n.

One skilled in the art, will understand that there are many possible implementations for the coding technique disclosed. For example, the basic bit rate clock at the decoder may be self-derived from the received signal and may be created by the use of, for example, a phase lock loop (PLL) and other circuitry.

Thus, what has been disclosed is a multi-level coding (encoding and decoding) method and apparatus that may be applied to a computer bus for data transfer. One skilled in the art will appreciate that the additive and subtractive functions referred to in the present invention may be practiced in the analog and/or digital signal domain.

What is claimed is:

1. A method comprising:
receiving an input signal;
delaying the input signal to create a delayed input signal; and
combining the input signal and the delayed input signal to create an output signal.

2. The method according to claim 1, wherein the input signal, and the output signal, are digital signals or analog signals, having a minimum bit period, and the delayed input signal is delayed the minimum bit period.

3. The method according to claim 1, wherein the combining is an operation selected from the group consisting of a modulo 2 binary addition, a modulo 2 binary subtraction, an exclusive-OR logic function, a digital adder, an analog adder, and a mixer.

4. The method according to claim 1, further comprising transferring the output signal to a bandwidth limited channel.

5. A method comprising:
receiving an input signal;
delaying an output signal to create a delayed output signal; and
combining the input signal and the delayed output signal to create the output signal.

6. The method according to claim 5, wherein the input signal, and the output signal, are digital signals or analog signals, having a minimum bit period, and the delayed output signal is delayed the minimum bit period.

7. The method according to claim 5, wherein the combining is an operation selected from the group consisting of a modulo 2 binary addition, a modulo 2 binary subtraction, an exclusive-OR logic function, a digital subtracter, an analog subtracter, and a mixer.

8. The method according to claim 5, further comprising receiving the input signal from a bandwidth limited channel.

9. An apparatus comprising:
an input port coupled to receive an input signal;
a delay unit having an input and an output, the delay unit input coupled to receive the input signal;
a combining unit having a first and a second input, and an output, the first input coupled to receive the input signal, the second input coupled to receive the delay unit output; and
an output port coupled to receive the combining unit output.

10. The apparatus of claim 9, wherein the combining unit is an exclusive-OR gate.

11. The apparatus of claim 9, wherein the delay unit further comprises a flip-flop.

12. An apparatus comprising:
an output port coupled to receive an output signal;
a delay unit having an input and an output, the delay unit input coupled to receive the output signal,
a combining unit having a first and a second input, and an output, the first input coupled to receive an input signal, the second input coupled to receive the delay unit output, and the output coupled to the output port; and
an input port coupled to receive the input signal.

13. The apparatus of claim 12, wherein the combining unit is an exclusive-OR gate.

14. The apparatus of claim 12, wherein the delay unit further comprises a flip-flop.

15. An apparatus comprising;
means for encoding computer data signals;
means for transferring the encoded computer data signals across a bandwidth limited bus; and
means for decoding the encoded computer data signals.

16. The apparatus of claim 15, wherein the means for encoding and means for decoding is means for duo-binary encoding and means for duo-binary decoding.

17. The apparatus of claim 15, wherein the computer data signals further comprise microprocessor data signals.

18. A machine-readable medium having stored thereon instructions, which when executed causes a system to:
receive signals internally from an integrated circuit logic unit source;
duo-binary encode the signals from the source; and
transmit the encoded signals.

19. The machine-readable medium according to claim 18, wherein the signals are digital signals or analog signals.

20. The machine-readable medium according to claim 18, wherein the logic unit is selected from the group consisting of a memory bus, a graphics bus, a serial bus, and a peripheral bus.

21. The machine-readable medium according to claim 20, wherein the encoded signals are transmitted outside the integrated circuit.

22. A processor system memory interface comprising:
a memory system input coupled to receive encoded data from a processor system source; and
a processor system input coupled to receive encoded data from a memory system source.

23. The apparatus of claim 22 wherein the encoded data is duo-binary encoded data.

24. The apparatus of claim 22 wherein the encoded data is n-level encoded data.

25. A method of N-level encoding comprising:
receiving an original input signal;
(a) receiving an input;
(b) delaying the original input signal K delays;
(c) summing the input and the K delayed signal to create an output; and
repeating (a)-(c) for K=1 to N wherein:
when K=1, receiving an input at (a) is receiving the original input signal;
when K=2 to N, receiving an input at (a) is receiving the output at (c) from an immediate previous (K−1) iteration; and
at K=N the output at (c) is a final output signal.

26. The method of claim 25 wherein the input is analog or digital.

27. A machine-readable medium having stored thereon instructions, which when executed causes a system to perform the method of claim 25.

28. An apparatus comprising:
an input port coupled to receive an input signal;
a plurality of delay units each unit having an input and an output, the first delay unit input coupled to receive the input signal and each successive delay unit input coupled to receive the output of the previous delay unit;
a plurality of combining units each unit having a first and a second input, and an output, the first combining unit input coupled to receive the input signal, the first combining unit second input coupled to receive the first delay unit output and each successive combining unit first input coupled to receive the output of the previous combining unit, and each successive combining unit second input coupled to receive the previous stage delay unit output; and
an output port coupled to receive a last stage combining unit output.

29. A method of N-level decoding comprising:
receiving a final output signal;
(a) receiving an input;
(b) delaying the final output signal K delays;
(c) differencing the input and the K delayed signal to create an output; and
repeating (a)-(c) for K=N to 1 wherein:
when K=N, receiving an input at (a) is receiving an original input signal;
when K=N−1 to 1, receiving an input at (a) is receiving the output at (c) from an immediate previous (K+1) iteration; and
at K=1 the output at (c) is the final output signal.

30. The method of claim 29 wherein the input is analog or digital.

31. A machine-readable medium having stored thereon instructions, which when executed causes a system to perform the method of claim 29.

32. An apparatus comprising:
an input port coupled to receive an input signal;
a plurality of delay units each unit having an input and an output, the last delay unit input coupled to receive a final output signal and each previous delay unit input coupled to receive the output of the later delay unit;
a plurality of combining units each unit having a first and a second input, and an output, the first combining unit input coupled to receive the input signal, the first combining unit second input coupled to receive the first delay unit output and each successive combining unit first input coupled to receive the output of the previous combining unit, and each successive combining unit second input coupled to receive the later stage delay unit output; and
an output port coupled to receive the final output from the last stage combining unit output.
